(19) United States
(12) Patent Application Publication
(10) Pub. No.: US 2023/0312989 A1
(43) Pub. Date: Oct. 5, 2023

(54) Display Stack Utilizing a Heat-Activated Adhesive Film

(71) Applicant: Google LLC, Mountain View, CA (US)

(72) Inventor: David Scott Moore, Mountain View, CA (US)

(73) Assignee: Google LLC, Mountain View, CA (US)

(21) Appl. No.: 18/330,884

(22) Filed: Jun. 7, 2023

Related U.S. Application Data
(60) Provisional application No. 63/505,221, filed on May 31, 2023.

(51) Int. Cl. C09J 7/35; C09J 7/38

(52) U.S. Cl. CPC C09J 7/35; C09J 7/38; C09J 2203/326; C09J 2301/312

(57) ABSTRACT

An electronic device, which comprises a display element and a heat-activated adhesive film (HAF). The heat-activated adhesive film may have a planar surface complementary to and in contact with a planar surface of the display element. Another planar surface for the HAF, opposite to the planar surface of the HAF in contact with the planar surface of the display element, is complementary to and in contact with a planar surface of a laminate layer. The HAF becomes adhesive and bonds to both the display element and the laminate by being exposed to a heat source. There may also be a pressure-sensitive adhesive (PSA) layer added to the laminate layer.

### SUMMARY

This application claims priority to U.S. Provisional Patent Application Ser. No. 63/505,221, filed on May 31, 2023, the disclosure of which is incorporated by reference herein in its entirety.

### SUMMARY

This document describes techniques and apparatuses directed to a display stack utilizing a heat-activated adhesive film. In particular, a heat-activated adhesive film (HAF) may be used to bond with a display element and a laminate layer in order to provide adhesion and water resistance.

One aspect of the disclosure provides an HAF layer, which may have a first planar surface complementary to and in contact with a planar surface of a display element. There may also be, opposite to the planar surface of the HAF in contact with the planar surface of the display element, a second planar surface for the HAF. The second planar surface of the HAF may be complementary to and in contact with a first planar surface of a laminate layer. Responsive to exposure to a heat source, the HAF may become adhesive and bond to both the display element and the laminate. The output of the heat source may be in the range of 60-130 degrees Celsius, or more or less.

According to some examples, a pressure-sensitive adhesive (PSA) layer may be added to the laminate layer. The PSA may have a planar surface complementary to and in contact with a planar surface of the laminate, the second planar surface of the laminate opposite to the first planar surface of the laminate in contact with the HAF. The second planar surface of the laminate in contact with the planar surface of the PSA may be bonded to the PSA by an application of pressure to the PSA. The makeup of the materials may be such that the entire height of the stack formed from the HAF, laminate, and PSA is no more than 0.5 mm.

According to some examples, there may be a central cavity in the HAF-laminate-PSA stack including one or more layers. If the cavity traverses multiple layers, it may be comprised of individual cavities for each layer and the individual cavities may be the same as one another.

This Summary is provided to introduce simplified concepts of a display stack utilizing a heat-activated adhesive film, which are further described in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of a display stack utilizing a heat-activated adhesive film are described in this document with reference to the following drawings:

FIG. 1 illustrates example implementations of display devices;

FIG. 2 illustrates a perspective view of a display stack using a pressure-sensitive adhesive and a trim piece;

FIG. 3 illustrates a display stack utilizing a heat-activated adhesive film; and

FIG. 4 illustrates a stacking method.

### DETAILED DESCRIPTION

### Overview

Portable electronic devices often require both a small form factor and waterproofing. Meeting both requirements can be difficult due to space constraints. Various techniques have been implemented, which aim to both reduce a material budget and increase water resistance, adhesion, and aid in repair. One of these techniques is to use a combination of a liquid-dispensed adhesive (LDA) and a plastic molded trim piece to mate a layer of pressure-sensitive adhesive (PSA) to a display element. The PSA acts as a disposable layer, allowing for replacement of the display or other components at a repair center. The LDA mates the trim piece to the display while the PSA is mated to the trim piece.

There are several drawbacks with using a display-LDA-trim-PSA stack. First, the thickness of the entire stack can be cumbersome in a physically constrained environment, such as a mobile computing device. The LDA-trim-PSA portion of the stack may be, for example, as much as 1 mm in thickness. Device manufacturers may be forced to, for example, compromise on the thickness of a device enclosure due to space constraints placed on the device due to the stack thickness, which in turn may lead to a degradation in reliability. Second, manufacture can be a multi-step process with non-trivial additional costs associated with application of the LDA. Third, cosmetic elements such as a position of various components within a housing may be negatively affected by the size of the stack.

To avoid these compromises, a thinner stack is required without sacrificing waterproof integrity of the device. The method used in this disclosure is to utilize a display stack with a heat-activated adhesive film (HAF) layer. The HAF and a layer of laminate material, such as a plastic material, replace the LDA and trim pieces in the display stack, forming a display-HAF-laminate stack. The display-HAF-laminate stack may decrease the overall thickness of the display stack by 50%, for example reducing a former stack thickness of 1 mm down to 0.5 mm. The overall decrease in thickness might be more or less than this amount, such as by 70% for a total thickness of 0.3 mm. The HAF layer has the added benefit over the LDA of not significantly deforming or flowing when activated by heat to achieve adhesion. This allows for the HAF to grant waterproofing to the display without intruding into other portions of the device.

The display-HAF-laminate stack may further be enhanced by addition of a PSA layer on the laminate layer. This allows for adhesion of the entire display-HAF-laminate-PSA stack within the device and for service of the device should the display element require removal. The PSA may serve as a disposable element, keeping the display-HAF-laminate portion intact and undamaged.

Surfaces for each of the layers that mate with other layers may be effectively smooth. Although the general shape of the surfaces is planar, it is also possible for there to be, in some embodiments, areas of a particular layer that deviate from a strictly plane-like, global geometry. Even so, these areas will still be effectively smooth and complementary with the layer they are mated to. This effective or substantial smoothness may mean that, even in the absence of a uniform plane-like shape, there may exist areas of local plane-like shapes. This may result in a surface which is locally planar but not globally planar.

In some embodiments, some or all of the layers may be in the shape of a slab. Some of these layers may also have a central cavity in the slab. If the cavity traverses multiple layers, it may be comprised of individual cavities, each of which may be complementary between adjacent layers.

Mating of the layers may be achieved by activating the HAF with a heat source. The heat source, which may vary in temperature, such as between 30 and 160 degrees Celsius, may be, for example, applied to the display-HAF-laminate-PSA stack in order to activate the HAF as an adhesive and bind the display layer to the laminate layer.

### Example Embodiments

The following discussion describes example implementations, techniques, and apparatuses that may be employed in the example implementations, and various devices in which components of a display stack utilizing a heat-activated adhesive film can be embodied. In the context of the present document, reference is made to the following by way of example only.

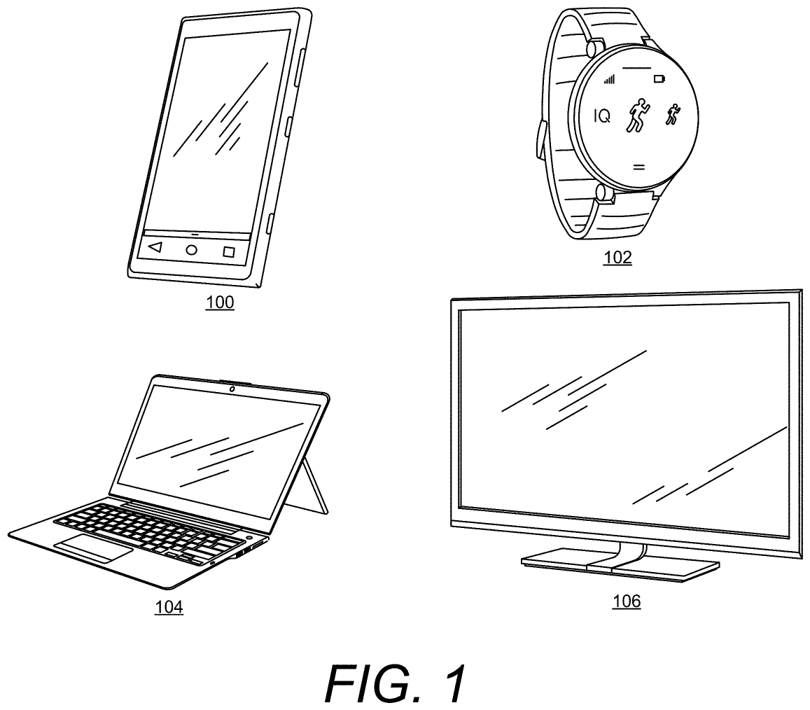

FIG. 1 shows example devices that may employ a technique of using a display-HAF-laminate stack. The device could be a smartphone 100, a smartwatch 102, a mobile computer 104 such as a laptop, an electronic display 106, or any number of devices with a digital screen. Devices may have components in addition to a display, cover glass, HAF, laminate, and PSA, including but not limited to processors, memories, and sensors. The devices displayed are meant to be exemplary and are not intended to limit the scope of the application.

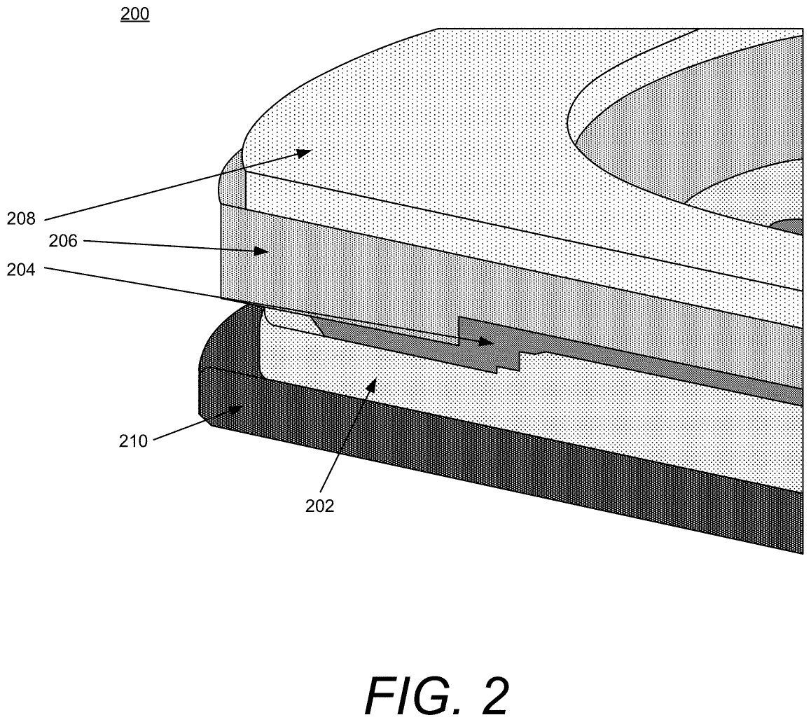

FIG. 2 shows a device using a method of stacking layers for adhering a display to a mobile device using an LDA and a trim piece. An entire stack 200 may be comprised of a display element layer 202, an LDA layer 204, a trim piece 206, and a PSA layer 208. The stack 200 may be inserted into a cover glass 210. Disadvantages to using this technique include an ability of the LDA to flow outside of the confines shown by the LDA layer 204, which can in turn lead to an inability to repair the device without damaging additional components. Additionally, the trim piece 206 is large compared with the other layers. This makes for a thicker stack of overall material than might otherwise be optimal.

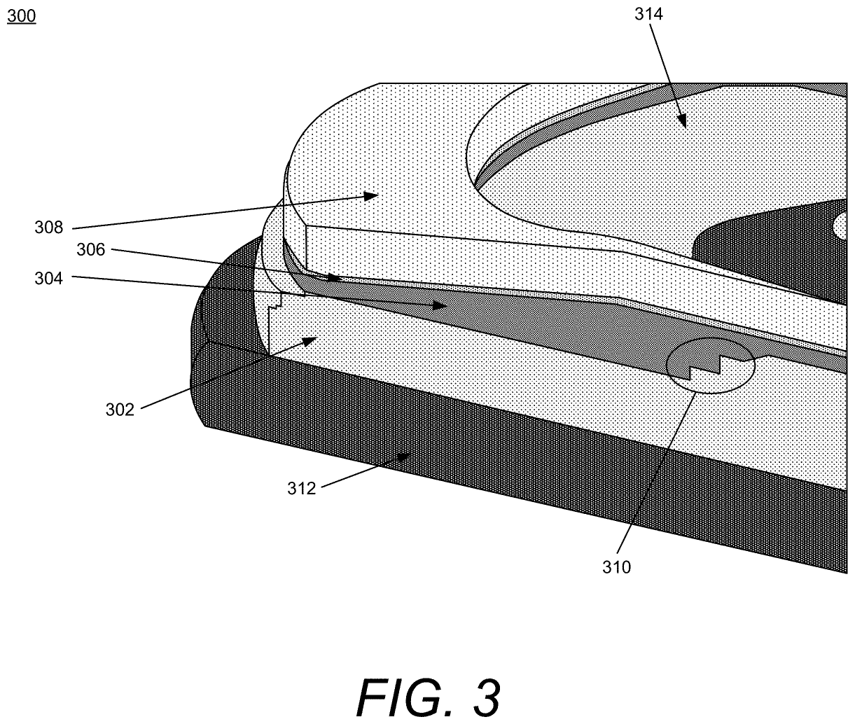

FIG. 3 shows a device using a method of creating a waterproof display stack by use of a HAF. A stack 300 may be comprised of a display element layer 302, a HAF layer 304, a laminate layer 306, and a PSA layer 308. It should be noted that some of these layers may not be necessary for the device's construction, such as the PSA layer 308 or laminate layer 306, and that other layers with additional functionality may be envisioned. This embodiment is not meant to be limiting against these sorts of variations.

Mating surfaces of the layers 302, 304, 306, and 308 are defined as the surfaces of the layers that come into contact with another layer. These mating surfaces may be substantially smooth surfaces. For instance, the mating surface of the display element layer 302 that comes into contact with the HAF 304 may be a substantially smooth surface, and, likewise, the corresponding mating surface of the HAF 304 may be a substantially smooth surface. Mating surfaces may, therefore, be flat or planar in nature.

Mating surfaces, although they may be locally planar, need not keep to a strictly planar shape for the entirety of the surface. Consider the HAF layer 304 and the laminate layer 306 shown in FIG. 3. The layers 304 and 306 may be in contact with one another along their substantially smooth, touching surfaces. These surfaces, as shown, may have areas where they are at an angle in relation to other layers in the stack 300. This does not change the relationship between mating layer surfaces, though, as they are parallel to one another in a complementary fashion. In this way, the mating surfaces may be locally planar to one another even if they are not globally planar or not planar to a surface with which they do not mate.

Additionally or alternately, there may be areas of non-conformity to a global planar surface, which do not follow a simple single angle deviation. By way of example, consider again the HAF layer 304 and the display element layer 302. There is an area with a “stair-step” sort of non-conformity 310 to a strictly global planar geometry. This non-conformity may be, but is not limited to, a display flex element. Non-conformity 310 is shown here to be representative of any general non-conformities to a strictly global planar geometry. Although this area may deviate from a globally planar shape, note that both layers 304 and 302 remain complementary in their mating surfaces and that locally there is still what amounts to a planar shape of each of the surfaces.

The use of the HAF 304 and the laminate 306 instead of the LDA 204 and the trim piece 206 may decrease an overall height of the stack 300 compared with the stack 200. By way of example only, the stack 200 may be 1 mm in height. The stack 300 may have a reduced height of only 0.5 mm or 0.3 mm, representing an overall decrease of 50% or 70%, respectively. This reduction may be realized without sacrificing an overall waterproof integrity of the device.

The display-HAF-laminate-PSA stack 300 may be placed in a cover glass 312. The reduction in height of the stack 300 over the stack 200 may allow for the cover glass 312 to be thicker than it otherwise would be. This may aid in overall structural rigidity of the device and/or in placement options for additional components such as speakers, microphones, processors, and so on (not pictured).

In some embodiments, some or all of the HAF-laminate-PSA layer stack may have a central cavity 314. The cavity 314 may be used to decrease overall materials used in manufacture, to house additional components of the device such as speakers, processors, sensors, etc. (not shown), or for both of these purposes or additional or alternate purposes. The potential utility of the cavity 314 in some or all of the layers in the stack should be seen not as a limitation but rather as an outline of the general utility in including the cavity 314 as part of the overall geometry of at least some of the layers in the stack.

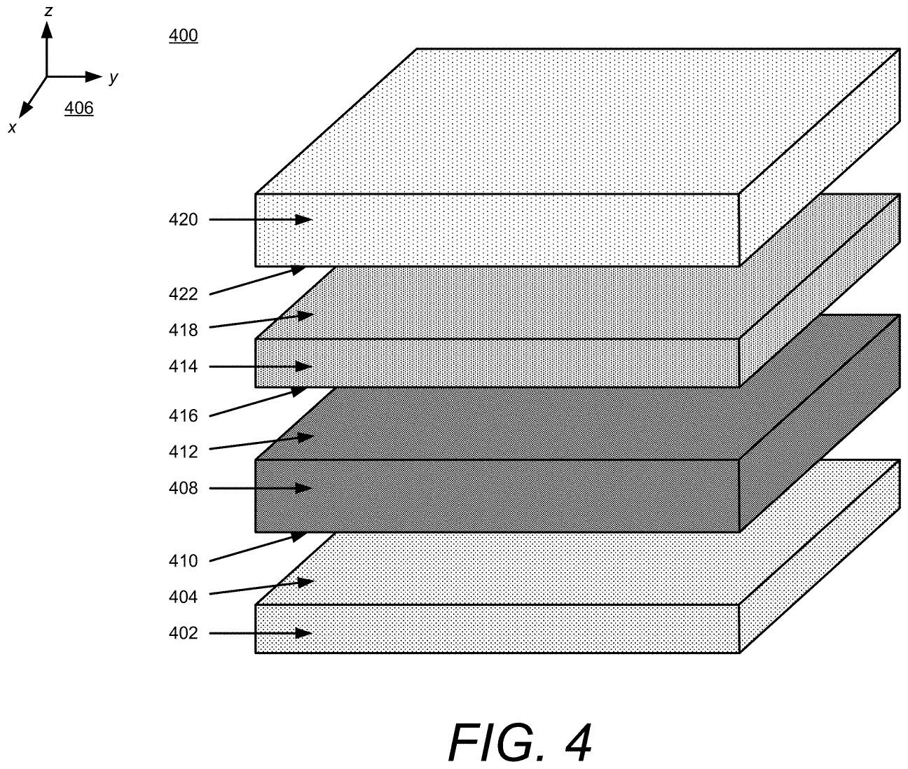

FIG. 4 is a simplified/idealized outline of layers in a display-HAF-laminate-PSA stack 400. For simplicity and ease of understanding, the stack 400 has been shown without a cavity and without any non-conformity to a strict, homogenous, global planar geometry. A display element layer 402 may be a rectangular slab with a major planar surface 404 extending in the x-y plane with the normal in the +z direction, according to an included axis 406. A HAF layer 408 may have a major planar surface 410 extending in the x-y plane with the normal in the −z direction. The surfaces 404 and 410 may be complementary, meaning they may be of a same geometry and surface area. Further, the surfaces 404 and 410 may have substantially smooth surfaces such that, when put against one another, their surface areas may be substantially touching.

The HAF layer 408 may have a second major planar surface 412 extending in the x-y plane with the normal in the +z direction. A laminate layer 414 may have a major planar surface 416 extending in the x-y plane with the normal in the −z direction. The surface 412 and the surface 416 may be, similarly to the surfaces 404 and 410, complementary. The shapes of the surfaces 412 and 416 may be such that, when they are brought into contact with one another, their surface areas may be substantially touching. The surfaces 412 and 416 may be substantially smooth surfaces.

A heat source (not pictured) may be applied to the HAF 408. An output of the heat source may be in a range of 60-130 degrees Celsius, or more or less. When exposed to the heat source, the HAF 408 may become adhesive. If the HAF 408 is in contact with the display element layer 402 and the laminate 414, as outlined previously, the HAF 408 may bond to the display element layer 402 and the laminate 414. This bonding may result in a water-impenetrable seal.

In addition to the display element layer 402, the HAF 408, and the laminate 414, there may be a PSA layer 420. The laminate layer 414 may have a second major planar surface 418 extending in the x-y plane with the normal in the +z direction. The PSA layer 420 may have a major planar surface 422 extending in the x-y plane with the normal in the −z direction. The surfaces 418 and 422 may be complementary to one another, in the same way that complementary surfaces have been described in previous paragraphs. An application of pressure to the PSA 420 may activate an adhesive property of the PSA 420, causing it to bond with the laminate 414.

### CONCLUSION

Although concepts of techniques and apparatuses directed to a display stack utilizing a heat-activated adhesive film have been described in language specific to techniques and/or apparatuses, it is to be understood that the subject of the appended claims is not necessarily limited to the specific techniques or apparatuses described. Rather, the specific techniques and apparatuses are disclosed as example implementations of a display stack utilizing a heat-activated adhesive film.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

What is claimed is:

1. An electronic device, the electronic device comprising:
a heat-activated adhesive film (HAF), the HAF:
comprising a first planar surface; and
comprising a second planar surface, the second planar surface substantially parallel to the first planar surface;
a display element, the display element comprising a third planar surface, the third planar surface:
complementary to the first planar surface;
oriented such that it is in direct contact with the first planar surface; and
adhered to the first planar surface by the HAF having been exposed to a heat source; and
a lamination material, the lamination material:
comprising a fourth planar surface; and
comprising a fifth planar surface:
substantially parallel to the fourth planar surface;
complementary to the second planar surface;
oriented such that it is in direct contact with the second planar surface; and
adhered to the second planar surface by the HAF having been exposed to the heat source.

2. The device of claim 1, wherein the first, second, third, fourth, and fifth planar surfaces are substantially smooth surfaces.

3. The device of claim 1, wherein the display element and the HAF have one or more regions of non-conformity to a plane, the one or more regions of non-conformity to a plane maintaining a complementary relationship between the first planar surface and the third planar surface.

4. The device of claim 1, further comprising a pressure sensitive adhesive (PSA), the PSA comprising a sixth planar surface, the sixth planar surface:
complementary to the fourth planar surface; and
oriented such that the sixth planar surface and the fourth planar surface are in direct contact with one another.

5. The device of claim 4, wherein a total thickness of the HAF, laminate, and PSA together does not exceed 0.5 mm.

6. The device of claim 4, wherein the HAF, laminate, and PSA further comprise a central cavity.

7. The device of claim 1, wherein the HAF is caused to adhere when exposed to a temperature in a range of 60-130 degrees Celsius.
